(19) United States
(12) Patent Application Publication
(10) Pub. No.: US 2025/0086029 A1
(43) Pub. Date: Mar. 13, 2025

(54) DISTRIBUTION MANAGEMENT OF COMPUTING OPERATION LIMITS

(71) Applicant: The Toronto-Dominion Bank, Toronto (CA)

(72) Inventors: Nicole Marie LARADE-TUNG, Toronto (CA); Niti TIKU, Brampton (CA); Mike KIKUVI MWANTHI, Mississauga (CA); Percy Richard GOLDING, Oakville (CA); Mohsen JALILVAND, Toronto (CA); Alexander AOLARITEI, Brampton (CA)

(73) Assignee: The Toronto-Dominion Bank, Toronto (CA)

(21) Appl. No.: 18/466,386

(22) Filed: Sep. 13, 2023

(51) Int. Cl. G06F 9/50

(52) U.S. Cl. CPC G06F 9/5077; G06F 9/5072

(57) ABSTRACT

Systems and methods for defining and distributing computing operation limits among different computing operation categories are provided. A system may define a first computing operation limit specific to a first computing operation category. The first computing operation category may be a computing operation of a first type in connection with a first resource account. The system may further define a pooled computing operation limit applicable to both the first computing operation category and to a second computing operation category. The system may then determine that a defined amount of data associated with a requested computing operation in connection with the first computing operation category exceeds the first computing operation limit. The system may then determine that the defined amount of data associated with the requested computing operation is within the pooled computing operation limit and may subsequently enable the requested computing operation.

### TECHNICAL FIELD

The present application relates to computing operation limit management, and, more particularly, to the definition and distribution of computing operation limits among different computing operation categories.

### BACKGROUND

The amount of data resources, (e.g., computer files), transferred across computer networks on a daily basis is so great that it is virtually immeasurable. A number of different computing operation types are presently available for transferring computer files from one location to another. These computing operation types may include, for example, File Transfer Protocol (FTP), File Transfer Protocol Secure (FTPS), Secure File Transfer Protocol (SFTP), Secure Copy Protocol (SCP), Trivial File Transfer Protocol (TFTP) and Managed File Transfer (MTP).

Computing operation limits may be associated with a computing operation category, i.e., with a type of computing operation in connection with an originating resource account. For example, an originating resource account (e.g., a source directory) may be subject to a first computing operation limit in connection with first type of computing operation (e.g., an FTP transfer), and may be further subject to one or more additional computing operation limits in connection with one or more additional types of computing operations (e.g. an FTPS transfer). Furthermore, pooled computing operation limits may be applicable to one or more computing operation categories.

A user or entity associated with one or more resource accounts to which one or more computing operation limits apply may find it difficult to determine and monitor the associated computing operation limits. Furthermore, the user or entity may have little control over how various limits are distributed across various accounts and computing operation types. As a result, there is a need for systems and methods to better understand, visualize, monitor, implement and reassign computing operation limits.

Improvements to the field are desired.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a high-level operation diagram of an example computing device;

FIG. 3 depicts an example simplified software organization of the example computing device of FIG. 2;

FIG. 4 is a flowchart showing operations for enabling a requested computing operation, in accordance with an embodiment of the present disclosure;

FIG. 5 is a flowchart showing operations for receiving a request to initiate a computing operation, in accordance with an embodiment of the present disclosure;

FIG. 6 shows a first example display screen of a first example user interface presented on a client device, in accordance with an embodiment of the present disclosure;

FIG. 7 shows a second example display screen of a first example user interface presented on a client device, in accordance with an embodiment of the present disclosure;

FIG. 8 shows a third example display screen of a first example user interface presented on a client device, in accordance with an embodiment of the present disclosure;

FIG. 9 shows a fourth example display screen of a first example user interface presented on a client device, in accordance with an embodiment of the present disclosure;

FIG. 10 shows a first example display screen of a second example user interface presented on a client device, in accordance with an embodiment of the present disclosure;

FIG. 11 shows a second example display screen of a second example user interface presented on a client device, in accordance with an embodiment of the present disclosure;

FIG. 12 shows a third example display screen of a second example user interface presented on a client device, in accordance with an embodiment of the present disclosure; and

FIG. 13 shows a fourth example display screen of a second example user interface presented on a client device, in accordance with an embodiment of the present disclosure.

Like reference numerals are used in the drawings to denote like elements and features.

### DETAILED DESCRIPTION OF VARIOUS EMBODIMENTS

A number of different computing operation types are presently available for transferring data from one location to another. Among these methods are File Transfer Protocol (FTP), File Transfer Protocol Secure (FTPS), Secure File Transfer Protocol (SFTP), Secure Copy Protocol (SCP), Trivial File Transfer Protocol (TFTP) and Managed File Transfer (MTP). There are advantages and disadvantages associated with each of these computing operation types. For example, FTP may be relatively quick and simple to use, and may transfer multiple directories of computer files at the same time. However, as FTP lacks encryption and requires the use of two data channels, the use of FTP may carry security risks. FTPS (also known as FTP/Secure Sockets Layer (SSL)) may include the benefits of FTP and may provide added security. However, FTPS may interfere with the operation of firewalls, which may make FTPS difficult to use in some environments. SFTP may also include the benefits of FTP, and, like FTPS, may provide added security. However, SFTP may be significantly slower than both FTP and FTPS. While SCP includes security features, and may be faster than SFTP in certain environments, it lacks file management capabilities, and offers little support for resume file transfers.

The advantages and disadvantages of each available computing operation type may be important considerations for a user wishing to transfer data resources. Another important consideration may be computing operation limits associated with each computing operation category. Some computing operation limits may be specific to a computing operation category, while some computing operation limits may be pooled, i.e., they may be applicable to more than one computing operation category. A computing operation category may be a computing operation of a particular type, (e.g., an FTP transfer), in connection with a particular resource account (e.g., a particular source directory).

For example, there may be a first computing operation limit specific to an FTP transfer from a first source directory and a second computing operation limit specific to an FTP transfer from a second source directory. The first and second specific limits may be aggregated to define a first pooled computing operation limit applicable to both an FTP transfer from a first source directory and an FTP transfer from a second source directory, and reassignment of the first and second specific limits associated with the first pooled limit may be provided.

Similarly, there may be a third computing operation limit specific to an SCP transfer from the first source directory, and the first and third specific limits may be aggregated to define a second pooled computing operation limit applicable to both an FTP transfer from the first source directory and an SCP transfer from the first source directory. Reassignment of the first and third specific limits associated with the second pooled limit may be provided.

In accordance with one aspect of the present disclosure, there is provided a computer system comprising a processor and a memory coupled to the processor. The memory stores instructions when executed by the processor, cause the computer system to: define a first computing operation limit specific to a first computing operation category, the first computing operation category being a computing operation of a first type in connection with a first resource account; define a pooled computing operation limit applicable to both the first computing operation category and to a second computing operation category; determine that a defined amount of data associated with a requested computing operation in connection with the first computing operation category exceeds the first computing operation limit; determine that the defined amount of data associated with the requested computing operation is within the pooled computing operation limit; and enable the requested computing operation.

In some implementations, a second computing operation limit specific to the second computing operation category is defined. Prior to enabling the requested computing operation, the system is further caused to reassign at least a portion of the second computing operation limit to the first computing operation limit.

In some implementations, the computer system is further caused to generate an updated first computing operation limit to reflect the defined amount of data associated with the requested computing operation and generate an updated pooled computing operation limit to reflect the defined amount of data associated with the requested computing operation.

In some implementations, the computer system is further caused to, prior to determining that a defined amount of data associated with a requested computing operation in connection with the first computing operation category exceeds the first computing operation limit: display, via a client device, a listing of one or more resource accounts, the listing including at least the first resource account; display, via the client device, in connection with each of the one or more resource accounts, an indication of at least one computing operation limit associated with one or more computing operation types, the one or more computing operation types including the computing operation of the first type; and receive, via the client device, a request to initiate the computing operation of the first type with respect to the defined amount of data in connection with the first resource account.

In some implementations, the computer system is further caused to display, via the client device, the updated first computing operation limit and the updated pooled operation limit.

In some implementations, the pooled computing operation limit is determined, at least in part, by an aggregation of the first computing operation limit and the second computing operation limit.

In some implementation, the pooled computing operation limit is further applicable to one or more additional computing operation categories, and is further determined by an additional aggregation of one or more additional computing operation limits associated with the one or more additional computing operation categories.

In some implementations, reassigning at least the portion of the second computing operation limit to the first computing operation limit includes applying a multiplier to the at least the portion of the second computing operation limit, the multiplier being based on a level of relative risk between the first computing operation category and the second computing operation category.

In some implementations, the second computing operation category is a computing operation of a second type in connection with the first resource account.

In some implementations, the second computing operation category is a computing operation of the first type in connection with a second resource account.

In accordance with another aspect of the present disclosure, there is provided a computer-implemented method. The computer-implemented method comprises: defining a first computing operation limit specific to a first computing operation category, the first computing operation category being a computing operation of a first type in connection with a first resource account; defining a pooled computing operation limit applicable to both the first computing operation category and to a second computing operation category; determining that a defined amount of data associated with a requested computing operation in connection with the first computing operation category exceeds the first computing operation limit; determining that the defined amount of data associated with the requested computing operation is within the pooled computing operation limit; and enabling the requested computing operation.

In some implementations, a second computing operation limit specific to the second computing operation category is defined. Prior to enabling the requested computing operation, the method further comprises reassigning at least a portion of the second computing operation limit to the first computing operation limit.

In some implementations, the method further comprises generating an updated first computing operation limit to reflect the defined amount of data associated with the requested computing operation and generating an updated pooled operation limit to reflect the defined amount of data associated with the requested computing operation.

In some implementations, the method further comprises, prior to determining that a defined amount of data associated with a requested computing operation in connection with the first computing operation category exceeds the first computing operation limit: displaying, via a client device, a listing of one or more resource accounts, the listing including at least the first resource account; displaying, via the client device, in connection with each of the one or more resource accounts, an indication of at least one computing operation limit associated with one or more computing operation types, the one or more computing operation types including the computing operation of the first type; and receiving, via the client device, a request to initiate the computing operation of the first type with respect to the defined amount of data in connection with the first resource account.

In some implementations, the method further comprises displaying, via the client device, the updated first computing operation limit and the updated pooled operation limit.

In some implementations, the pooled computing operation limit is determined, at least in part, by an aggregation of the first computing operation limit and the second computing operation limit.

In some implementations, the pooled computing operation limit is further applicable to one or more additional computing operation categories and is further determined by an additional aggregation of one or more additional computing operation limits associated with the one or more additional computing operation categories.

In some implementations, reassigning at least the portion of the second computing operation limit to the first computing operation limit includes applying a multiplier to the at least the portion of the second computing operation limit, the multiplier being based on a level of relative risk between the first computing operation category and the second computing operation category.

In some implementations, the second computing operation category is a computing operation of a second type in connection with the first resource account.

In some implementations, the second computing operation category is a computing operation of the first type in connection with a second resource account.

In accordance with yet another aspect of the present disclosure, there is provided a non-transitory computer readable medium. The non-transitory computer readable medium contains instructions which, when executed by a processor, cause the processor to: define a first computing operation limit specific to a first computing operation category, the first computing operation category being a computing operation of a first type in connection with a first resource account; define a pooled computing operation limit applicable to both the first computing operation category and to a second computing operation category; determine that a defined amount of data associated with a requested computing operation in connection with the first computing operation category exceeds the first computing operation limit; determine that the defined amount of data associated with the requested computing operation is within the pooled computing operation limit; and enable the requested computing operation.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

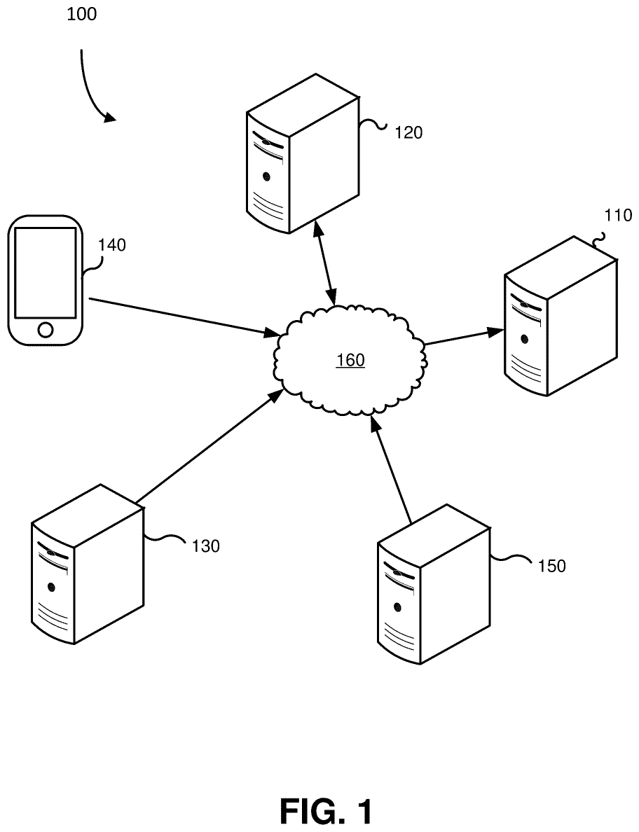

FIG. 1 is a schematic operation diagram illustrating an operating environment of an example embodiment.

As illustrated, the example operating environment 100 includes a first resource management system 110, a second resource management system 120, a file transfer system 150, a transfer rail system 130, and a client device 140 in communication via a network 160.

Each of the first resource management system 110, the client device 140, the second resource management system 120, the file transfer system 150, and the transfer rail system 130 may be in geographically disparate locations. Put differently, one or more of the first resource management system 110, the client device 140, the second resource management system 120, the file transfer system 150, and the transfer rail system 130 may be remote to others of the first resource management system 110, the client device 140, the second resource management system 120, the file transfer system 150, and the transfer rail system 130.

The first resource management system 110, the client device 140, the second resource management system 120, the file transfer system 150, and the transfer rail system 130 are computer systems. Computer systems may be, for example, a mainframe computer, a minicomputer, or the like. Computer systems may include one or more computing devices. For example, a computer system may include multiple computing devices such as, for example, database servers, computer servers, and the like. The multiple computing devices may be in communication using a computer network. For example, computing devices may communicate using a local-area network (LAN). In some embodiments, computer systems may include multiple computing devices organized in a tiered arrangement. For example, a computer system may include middle-tier and back-end computing devices. In some embodiments, a computer system may be a cluster formed of a plurality of interoperating computing devices.

The first and second resource management systems 110, 120 may each be a single server, multiple servers, a server farm, or any other such arrangement of computing devices to implement computing server-like functionality. In some embodiments, the first and second resource management systems 110, 120 may track, manage, and maintain resources. The resources may, for example, be computer code, spreadsheet data, and/or database information and may include image, text, audio and/or video files. Additionally or alternatively, the resources may be computing resources, such as memory or processor cycles. Additionally or alternatively, the resources may be digital goods, such as digital media resources; fonts, logos, photos and graphics; digital subscriptions; online advertisements; internet coupons; electronic tickets; electronic documentation; downloadable software and/or mobile apps; cloud-based applications and online games; virtual goods used within the virtual economies of online games and communities; workbooks; worksheets; planners; e-learning (online courses); webinars, video tutorials; blog posts; cards; patterns; website themes; and/or templates. Examples of digital media resources include e-books, downloadable music, internet radio, internet television and/or streaming media. The resources may be a specific type of digital goods known as digital assets, and may include photography, logos, illustrations, animations, audiovisual media, presentations, spreadsheets, digital paintings, word documents, electronic mails, websites, and a multitude of other digital formats and their respective metadata. Digital assets may be subject to digital rights management (DRM) and/or digital asset management (DAM). By way of further example, the resources may be database resources, and may represent stored value, such as financial instruments, including fiat currency and cryptocurrency. In at least some implementations, the resources may be or include digital goods which are exchange mediums. For example, the digital goods may be or represent monetary instruments.

In some embodiments, the first and second resource management systems 110, 120 may track, manage, and maintain owned resources belonging to respective entities. The resources may be represented in a database, and the database may be provided in secure storage(s). The secure storage(s) may be provided internally within the first and second resource management systems 110, 120 or externally. The secure storage(s) may, for example, be provided remotely from the first and second resource management systems 110, 120. For example, the secure storage(s) may include one or more data centers. The data centers may, for example, store data with bank-grade security.

In some embodiments, the first and second resource management systems 110, 120 may include records for a plurality of resource accounts and at least some of the records may define a quantity of resources. A first entity may be associated with one or more accounts storing or otherwise reflecting owned resources, i.e., an owned resource account. The records may reflect a first quantity of stored resources that are associated with the first entity. Such resources may include owned resources. The amount of resources associated with the entity may be reflected by a resource definition defined in an associated resource record. The resource definition may be or include a balance defined in an associated record; for example a bank balance. In some implementations, the resource definition may define one or more digital goods and/or digital assets that are associated with the first entity.

In some embodiments, the first and second resource management systems 110, 120 may be the same system.

As shown in FIG. 1, the example operating environment 100 may include one or more file transfer systems 150. The file transfer system 150 may be associated with a third-party and may be configured to receive a computing operation request, such as a resource (e.g., data file) transfer request. The file transfer system 150 may be associated with one or more file transfer protocols, such as, for example, FTP, FTPS, SFTP, SCP. TFTP and/or MTP. The file transfer system may include one or more servers operating one or more file transfer protocols, such as, e.g., an FTP protocol, an FTPS protocol, an SFTP protocol, an SCP protocol, a TFTP protocol, or an MTP protocol, etc. The file transfer system 150 may be configured to receive a computing operation request, e.g., a data transfer request. The data transfer request may include a request to transfer data from a first resource account and/or first data location to a destination resource account and/or destination data location. The first resource account may be, for example, associated with the first resource management system 110 and the destination resource account may be associated with the second resource management system 120.

As also shown in FIG. 1, the example operating environment 100 may include one or more transfer rail systems 130. The transfer rail system 130 may be associated with a third-party and may be configured to receive a computing operation request, such as a resource (e.g., data) transfer request. The resource transfer request may include a request to transfer resources from a first data record associated with a first resource account at a first location, which may be the first resource management system 110, to a destination data record associated with a destination resource account at a second location, which may be the second resource management system 120.

The transfer rail system 130 may be a computing system that facilitates electronic transfer of financial resources and may, in at least some embodiments, be referred to as a payment rail system. By way of example, the transfer rail system 130 may be an electronic funds transfer (EFT) system, a wire transfer system, a real time rail transfer (RTR) system and/or an email money transfer (EMT) system. The transfer rail system 130 may be or include one or more of a Visa™. Mastercard™. American Express™, or other value transfer card (e.g., credit card) rail. The request to transfer resources may be a request to transfer data such as, for example, units of value. The units of value may include a quantity of currency. In some embodiments where the transfer rail system 130 is a computing system that facilitates electronic transfer of financial resources, the first and second resource management systems 110, 120 may be, for example, computer systems associated with one of more financial institutions, such as a bank.

In some embodiments where the transfer rail system 130 is a payment rail system, the first resource management system 110 may be, for example, a computer system associated with a financial institution, such as a bank, that issued a corresponding value transfer card. Put differently, the first resource management system 110, may be associated with a value transfer card issuer. For example, the first resource management system 110 may be operated or managed by the value transfer card issuer.

The client device 140 may be used, for example, to configure a computing operation, such as a resource transfer, to be facilitated by the file transfer system 150. In some embodiments, the client device may be used to access the file transfer system 150.

In some embodiments, the client device may be used to request a computing operation, such as a resource transfer, to be facilitated by the transfer rail system 130. The resource transfer may, for example, involve a transfer of data, via the transfer rail system 130, between a first data record at the first resource management system 110 associated with a first account at the first resource management system 110 and a destination data record associated with a destination account at the second resource management system 120. The first resource account may belong to an entity operating the client device. The data involved in the resource transfer may, for example, be units of value and the records involved in the resource transfer may be adjusted in related or corresponding manners. For example, during a resource transfer, a record associated with an intended recipient (i.e., transferee) of the transfer may be adjusted to reflect an increase in value resulting from the transfer, whereas the record associated with the entity (i.e., transferor) initiating the transfer may be adjusted to reflect a decrease in value which is at least as large as the increase in value applied to the record associated with the recipient.

The client device 140 is also a computing device. In some embodiments, the client device 140 may, as illustrated, be a personal computer such as a smart phone. However, the client device 140 may be a computing device of another type such as a laptop computer, a desktop computer, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments. In certain embodiments, the client device 140 may be associated with one or more users. The one or more users may be associated with an entity, such as a user or client, having resources associated with the first resource management system 110. In some implementations, a user may operate the client device 140 to cause the client device 140 to perform one or more operations consistent with the disclosed embodiments. In some embodiments, the client device 140 may include a smart card, chip card, integrated circuit card (ICC), and/or other card having an embedded integrated circuit.

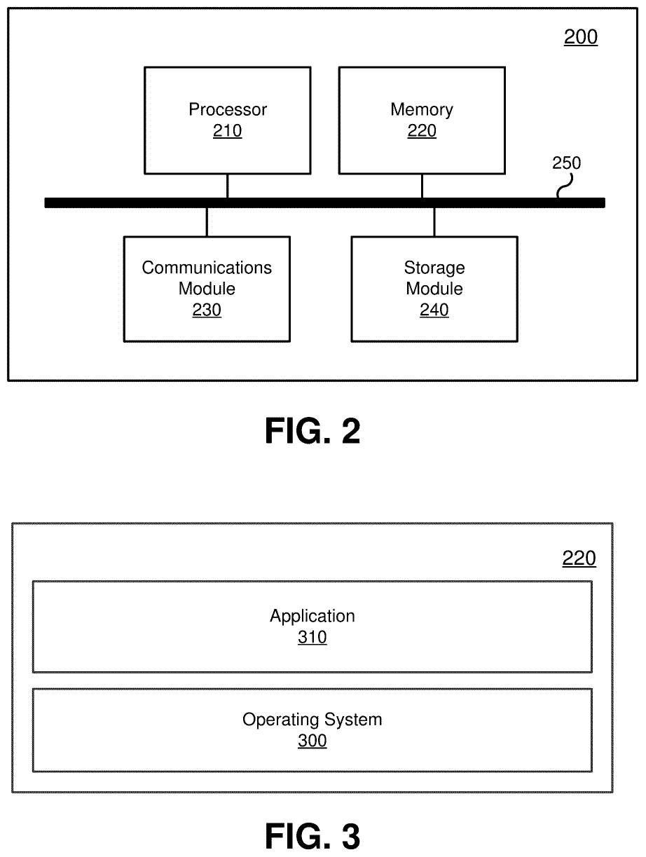

Referring now to FIG. 2, a high-level operation diagram of an example computing device 200 will now be described. The example computing device 200 may be exemplary of the first resource management system 110, the client device 140, the second resource management system 120, the file transfer system 150, and/or the transfer rail system 130.

The example computing device 200 includes numerous different modules. For example, as illustrated, the example computing device 200 may include a processor 210, a memory 220, a communications module 230, and/or a storage module 240. As illustrated, the foregoing example modules of the example computing device 200 are in communication over a bus 250.

The processor 210 is a hardware processor. The processor 210 may, for example, be one or more ARM, Intel x86, PowerPC processors or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computing device 200.

The communications module 230 allows the example computing device 200 to communicate with other computing devices and/or various communications networks. For example, the communications module 230 may allow the example computing device 200 to send or receive communications signals. Communications signals may be sent or received according to one or more protocols or according to one or more standards. For example, the communications module 230 may allow the example computing device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 230 may allow the example computing device 200 to communicate using near-field communication (NFC), via WiFi™, using Bluetooth™, or via some combination of one or more networks or protocols. In some embodiments, all or a portion of the communications module 230 may be integrated into a component of the example computing device 200. For example, the communications module may be integrated into a communications chipset.

The storage module 240 allows the example computing device 200 to store and retrieve data. In some embodiments, the storage module 240 may be formed as a part of the memory 220 and/or may be used to access all or a portion of the memory 220. Additionally, or alternatively, the storage module 240 may be used to store and retrieve data from persisted storage other than the persisted storage (if any) accessible via the memory 220. In some embodiments, the storage module 240 may be used to store and retrieve data in a database. A database may be stored in persisted storage. Additionally, or alternatively, the storage module 240 may access data stored remotely such as, for example, as may be accessed using a local area network (LAN), wide area network (WAN), personal area network (PAN), and/or a storage area network (SAN). In some embodiments, the storage module 240 may access data stored remotely using the communications module 230. In some embodiments, the storage module 240 may be omitted and its function may be performed by the memory 220 and/or by the processor 210 in concert with the communications module 230 such as, for example, if data is stored remotely. The storage module may also be referred to as a data store.

Software comprising instructions is executed by the processor 210 from a computer-readable medium. For example, software may be loaded into random-access memory from persistent storage of the memory 220. Additionally, or alternatively, instructions may be executed by the processor 210 directly from read-only memory of the memory 220.

The example computing device 200 will include other components apart from those illustrated in FIG. 2 and the specific component set may differ based on whether the example computing device 200 is operating as the first resource account management system, the client device, the second resource account management system, and/or the transfer rail system. For example, the example computing device 200 may include one or more input modules, which may be in communication with the processor 210 (e.g., over the bus 250). The input modules may take various forms including, for example, a mouse, a microphone, a camera, a touchscreen overlay, a button, a sensor, etc. By way of further example, the example computing device 200 may include one or more output modules, which may be in communication with the processor 210 (e.g., over the bus 250). The output modules include one or more display modules which may be of various types including, for example, liquid crystal displays (LCD), light emitting diode displays (LED), cathode ray tube (CRT) displays, etc. By way of further example, the output modules may include a speaker.

Software comprising instructions is executed by the processor 210 from a computer-readable medium. For example, software may be loaded into random-access memory from persistent storage of the memory 220. Additionally or alternatively, instructions may be executed by the processor 210 directly from read-only memory of the memory 220.

FIG. 3 depicts a simplified organization of software components stored in the memory 220 of the example computer device 200. As illustrated these software components include an operating system 300 and an application 310.

The operating system 300 is software. The operating system 300 allows the application 310 to access the processor 210, the memory 220, and the communications module 230. The operating system 300 may be, for example, UNIX™, Linux™, Microsoft™, Windows™, Apple™, Apple OSX™, Android™ or the like.

The application 310 adapts the example computing device 200, in combination with the operating system 300, to operate as a device to a particular function. For example, the application 310 may cooperate with the operating system 300 to adapt a suitable embodiment of the example computing device 200 to operate as the first resource account management system, the client device, the second resource account management system, the file transfer system, and/or the transfer rail system.

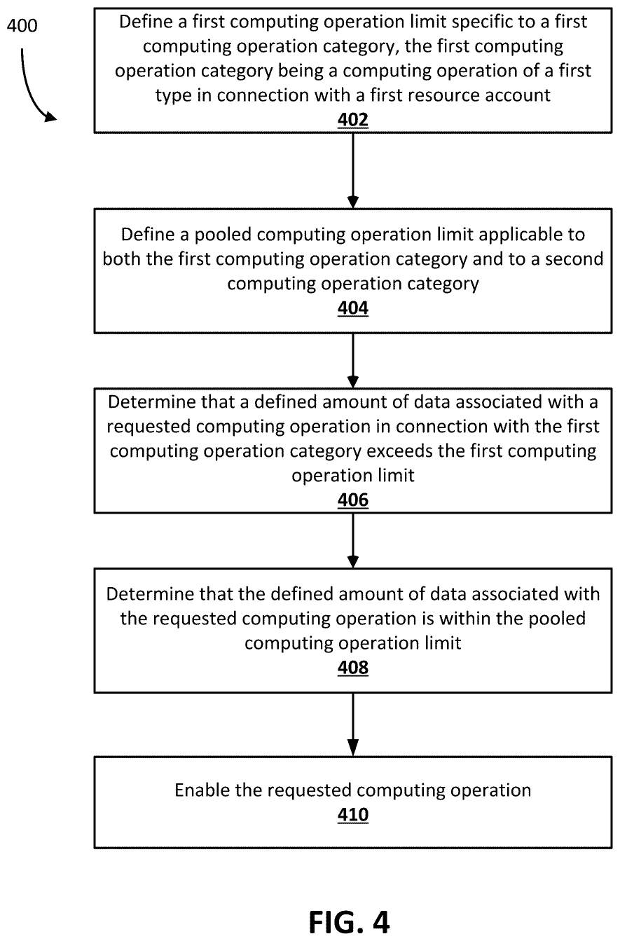

The operation of the first resource management system 110 (FIG. 1) will now be described with reference to the flowchart of FIG. 4 which illustrates a method 400 for enabling a requested computing operation. Operations 402 and onward are performed by one or more processors of a computing device, such as for example the processor 210 of a suitably configured instance of the example computing device 200, executing software such as, for example, a suitable instance of the application 310.

At the operation 402, the system defines a first transfer limit specific to a first computing operation category. The first computing operation category may be a computing operation of a first type in connection with a first resource account.

As a first example, a first resource account may be a source directory containing data resources available for transfer. A computing operation of a first type may be a file transfer facilitated by a file transfer system such a computer server operating one or more of an FTP protocol, an FTPS protocol, an SFTP protocol, an SCP protocol, a TFTP protocol, or an MTP protocol. A computer operation category may be, for example, an FTP transfer from a first source directory. A first transfer limit specific to the first operation category may be defined, for example, as 500 MB of data.

As a second example, a first resource account may be an account storing or otherwise reflecting owned or borrowed resources, e.g., a financial institution account. A computing operation of type may be a resource transfer facilitated by a transfer rail system such as an ETF system, an EMT system, a wire transfer system, and/or an RTR system. A computer operation category may be, for example, an ETF transfer from a first financial institution account. A first transfer limit specific to the first operation category may be defined, for example, as $1000.00.

As a third example, the computing operation category may be an account storing or otherwise reflecting owned or borrowed resources, e.g., a financial institution account. A computing operation type may be a resource transfer facilitated by a transfer rail system such as a Visa™, Mastercard™, American Express™, or other transfer card (e.g., credit card) rail system. A computing operation category may be an online Visa™ card transaction from a first financial institution account. The corresponding specific first transfer limit may be defined, for example, as $5000.00. The corresponding specific first transfer limit may be a credit limit.

At the operation 404, the system defines a pooled computing operation limit applicable to both the first computing operation category and to a second computing operation category.

In the first example, a pooled computing operation category may be applicable to both a first computing operation category (e.g., an FTP transfer from a first source directory) and to a second computing operation category (e.g. an FTP transfer from a second source directory). A pooled computing operation limit applicable to both the first computing operation category and the second computing operation category may be, for example, 1 GB of data.

In the second example, a pooled operation category may be applicable to both a first computing operation category (e.g., an EFT transfer from a first resource account) and to a second operation category (e.g., an EFT transfer from a second resource account). A pooled computing operation limit applicable to both the first computing operation category and the second computing operation category may be defined, for example, as $2,000.00.

In the third example, a pooled operation category may be applicable to both a first computing operation category (e.g., an online Visa™ transaction from a first resource account) and to a second operation category (e.g., an online Mastercard™ transaction from a second resource account). A pooled computing operation limit applicable to both the first computing operation category and the second computing operation category may be defined, for example, as $10,000.00. The pooled computing operation limit may be a pooled credit limit.

At the operation 406, the system determines that a defined amount of data associated with a requested computing operation in connection with the first computing operation category exceeds the first computing operation limit.

In the first example, the requested computing operation may include a request for an FTP transfer from a first source directory of a defined amount of 1 GB of data. In this example, the defined amount of data (i.e., 1 GB) exceeds the first computing operation limits (i.e., 500 MB).

In the second example, the requested computing operation may include a request for an EMT transfer from a first resource account of a defined amount of $1500.00. In this example, the defined amount of data (i.e., $1500.00) exceeds the first computing operation limits (i.e., $1000.00).

In the third example, a requested computing operation may include a request for an online Visa™ transaction from a first resource account of a defined amount of $7000.00. In this example, the defined amount of data (i.e., $7000.00) exceeds the first computing operation limits (i.e., $5000.00).

At the operation 408, the system determines that the defined amount of data associated with the requested computing operation is within the pooled computing operation limit.

In the first example, the defined amount of data (i.e., 1 GB) is within the pooled computing operation limit (i.e., 1 GB).

In the second example, the defined amount of data (i.e., $1500.00) is within the pooled computing operation limit (i.e., $2000.00).

In the third example, the defined amount of data (i.e., $7000.00) is within the pooled computing operation limit (i.e., $10,000).

In some embodiments, a second computing operation limit specific to the second computing operation category may be defined. In some such embodiments, the system may reassign at least a portion of the second computing operation limit to the first computing operation limit. In the first example, the system may reassign a portion of 500 MB of the second computing operation limit to the first computing operation limit. As a result, the first computing operation limit may be redefined as 1 GB. In the second example, the system may reassign a portion of $500.00 of the second computing operation limit to the first computing operation limit. As a result, the first computing operation limit may be redefined as $1500.00. In the third example, the system may reassign $2000.00 of the second computing operation limit to the first computing operation limit. As a result, the first computing operation limit may be redefined as $7000.00. At the operation 410, the system enables the requested computing operation.

In the first example, the system may enable a requested computing operation including a request for an FTP transfer from a first source directory of the defined amount of 1 GB of data.

In the second example, the system may enable a requested computing operation including a request for an EFT transfer from a first resource account of the defined amount of $1500.00.

In the third example third example, the system may enable a requested computing operation including a request for an online Visa™ transaction from a first resource account of the defined amount of $7000.00.

In some embodiments, subsequent to enabling the requested computing operation, the system may generate an updated first computing operation limit and may further generate an updated pooled computing operation limit.

Accordingly, in the first example, the system may generate an updated first computing operation limit of 0 MB and may further generate an updated pooled computing operation limit of 0 MB. In the second example, the system may generate an updated first computing operation limit of $0.00 and may further generate an updated pooled computing operation limit of $500.00. In the third example, the system may generate an updated first computing operation limit of $0.00 and may generate an updated pooled computing operation limit of $3000.00.

In some embodiments, the pooled computing operation limits are applicable to a first computing operation category and a second computing operation category. As noted, a computing operation category may be a computing operation of a particular type, (e.g., an FTP transfer), in connection with a particular resource account (e.g., a particular source directory). The examples of FIG. 4 describe embodiments where the first computing operation category is a computing operation of a first type in connection with a first resource account, and the second computing operation category is a computing operation of the first type in connection with a second resource account.

In some embodiments, however, the second computing operation category may be a computing operation of a second type in connection with the first resource account.

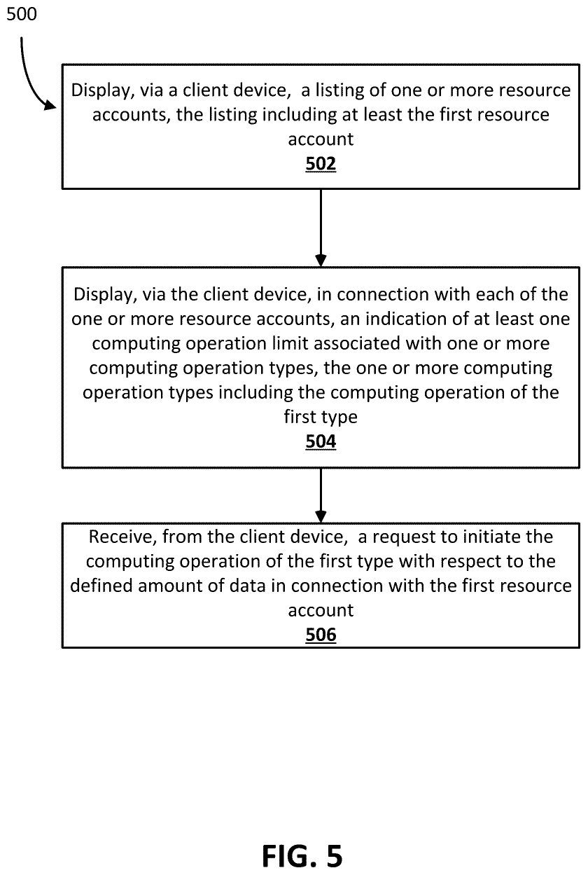

The operation of the first resource management system 110 (FIG. 1) will now be described with reference to the flowchart of FIG. 5, which illustrates a method 500 for receiving a request to initiate a computing operation, in accordance with embodiments of the present disclosure. Operations 502 and onward are performed by one or more processors of a computing device, such as for example the processor 210 of a suitably configured instance of the example computing device 200, executing software such as, for example, a suitable instance of the application 310.

At the operation 502, the system displays, via a client device, a listing of one or more resource accounts, the listing including at least the first resource account.

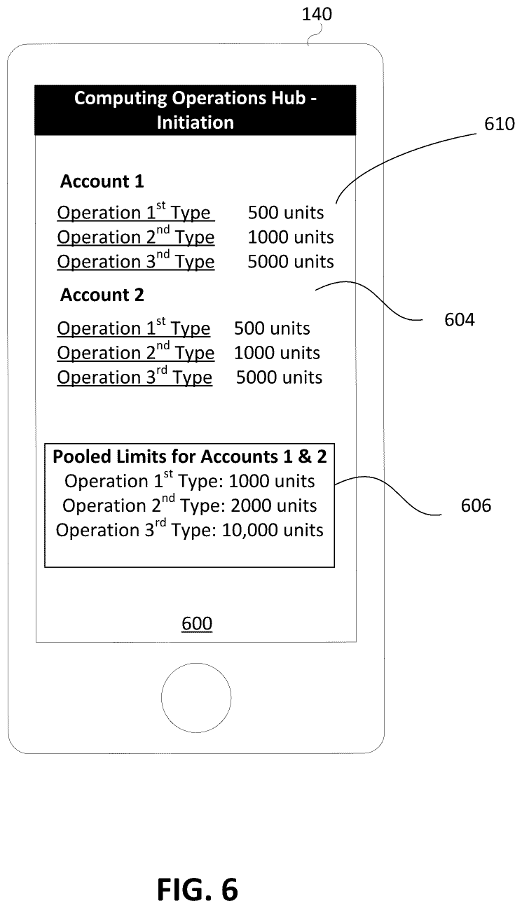

Reference is now made to FIG. 6, which illustrates a first example display screen 610 of a first example user interface 600 presented on a client device 140. The first example user interface 600 may provide for the initiation of a computing operation. As shown, the first example display screen 610 displays a title, “Computing Operations Hub-Initiation”. The example display screen 610 also displays, in a first area 604, a listing of two resource accounts, Account 1 and Account 2. The first example display screen 610 allows a user to easily identify computing operation limits applicable to particular accounts and/or computing operation types.

Returning again to FIG. 5, after the operation 502, the operation 504 is next.

At the operation 504, the system displays, via the client device, in connection with each of the one or more resource accounts, an indication of at least one computing operation limit associated with one or more computing operation types, the one or more computing operation types including the computing operation of the first type.

Returning again to FIG. 6, as shown, the first example display screen 610 of the first example user interface 600 also displays, in the first area 604, computing operations and associated limits specific to each of the two resource accounts: Account 1 and Account 2. Three distinct computing operations are listed with respect to each of Account 1 and Account 2: “Operation 1^{st} Type”, “Operation 2^{nd} Type”, and “Operation 3^{rd} Type”.

With respect to Account 1, as shown, the computing operation limit associated with “Operation 1^{st} Type” is identified as 500 units; the computing operation limit associated with “Operation 2^{nd} Type” is identified as 1000 units; and the computing operation limit associated with “Operation 3^{rd} Type” is identified as 5000 units.

With respect to Account 2, as shown, the computing operation limit associated with “Operation 1^{st} Type” is identified as 500 units; the computing operation limit associated with “Operation 2^{nd} Type” is identified as 1000 units; and the computing operation limit associated with “Operation 3^{rd} Type” is identified as 5000 units.

As shown, a second area 606 of the first example display screen 610 lists the pooled limits for Account 1 and Account 2 with respect to each of computing operations “Operation 1^{st} Type”, “Operation 2^{nd} Type”, and “Operation 3^{rd} Type”. The pooled computing operation limit for the “Operation 1^{st} Type” is identified as 1000 units, the pooled computing operation limit for the “Operation 2^{nd} Type” is identified as 2000 units, and the pooled computing operation limit for the “Operation 3^{rd} Type” is identified as 10,000 units.

The first example display screen 610 may provide computing operation controls. For example, one or more selectable options may be provided for inputting a computing operation instruction. For example, the operation type listings specific to each account may each include a virtual button.

Returning again to FIG. 5, after the operation 504, the operation 506 is next.

At the operation 506, the system receives, via the client device, a request to initiate the computing operation of the first type with respect to the defined amount of data in connection with the first resource account.

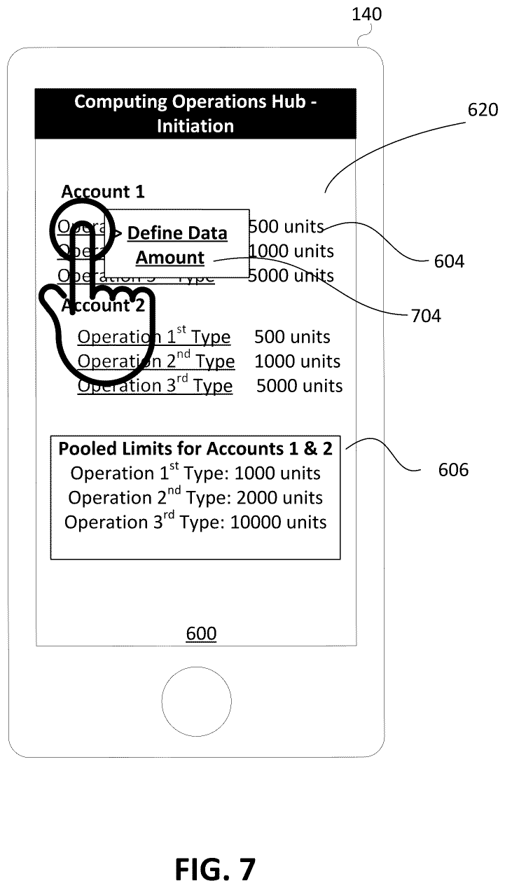

Referring now to FIG. 7, a second example display screen 620 of the first example user interface 600 is illustrated. The second example display screen 620 includes the components of the first example display screen 610 of FIG. 6. Additionally, the second example display screen 620 includes one or more selectable options 704 to define a data amount in connection with one or more computing operations specific to resource Account 1 or resource Account 2. Other selectable options may be provided instead of or in addition to this option.

The of one or more selectable options 704 to define a data amount is shown with respect to the “Operation 1^{st} Type” in connection with Account 1.

The one or more selectable options 704 to define a data amount may be displayed when a user activates or otherwise selects one of the listed computing operations associated with a specific resource account. In some embodiments, such selection may be made using a touchscreen associated with the client device 140, although other techniques are contemplated.

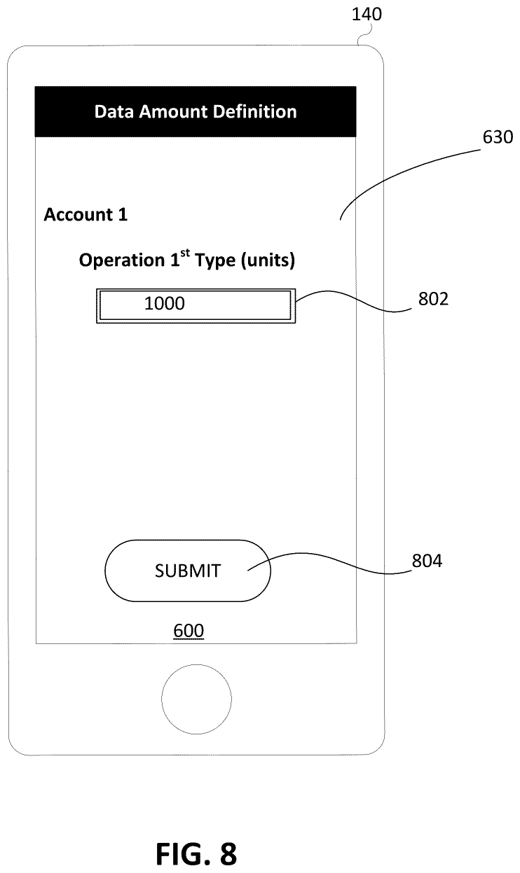

Upon selection of the one or more selectable options 704 to define a data amount in association with the selected computing option, the client device 140 may then display a third example display screen 630 (FIG. 8) of the first example user interface 600.

Reference is now made to FIG. 8, which illustrates a third example display screen 630 of the first example user interface 600 for receiving a data amount definition in association with the computing operation.

The third example display screen 630 includes an input field 802 for defining the data amount in association with the selected computing operation.

As shown, the third example display screen 630 further includes a title, “Data Amount Definition”. The third example display screen 630 further includes an indication of the resource account (“Account 1”) and the computing operation (“Operation 1^{st} Type”) to which the data amount relates. As shown, a data amount reflecting 1000 units has been entered in the input field 802. A “SUBMIT” button 804 is additionally included by the third example display screen 630.

In some embodiments, subsequent to receiving a request to initiate the computing operation of the first type with respect to the defined amount of data in connection with the first resource account, the system may display, via the client device, the updated first computing operation limit and the updated pooled operation limit.

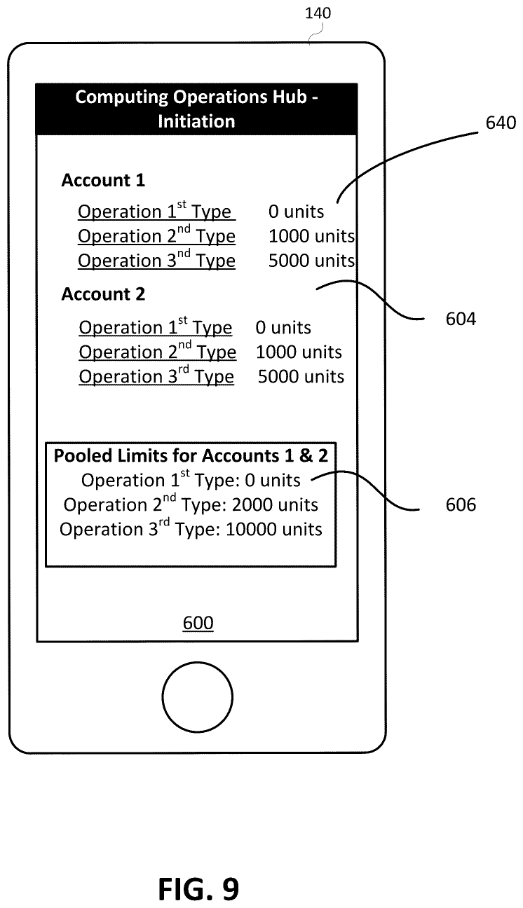

Reference is now made to FIG. 9, which illustrates a fourth example display screen 640 of a first example user interface 600 presented on a client device 140. The fourth example display screen 640 illustrates an example listing of specific and pooled computing operation limits associated with two listed resource accounts, Account 1 and Account 2, subsequent to receiving a request to initiate the computing operation of the first type (i.e., “Operation 1^{st} Type”) with respect to a defined amount of data of 1000 units in connection with the first resource account (i.e., Account 1).

As shown, the fourth example display screen 640 displays a title, “Computing Operations Hub-Initiation”. The example display screen 640 of the first example user interface 600 also displays, in the first area 604, computing operations and associated limits specific to each of the two resource accounts: Account 1 and Account 2. Three distinct computing operations are listed with respect to each of Account 1 and Account 2: “Operation 1^{st} Type”, “Operation 2^{nd} Type”, and “Operation 3^{rd} Type”.

With respect to Account 1, as shown, the computing operation limit associated with “Operation 1^{st} Type” is identified as 0 GB; the computing operation limit associated with “Operation 2^{nd} Type” is identified as 1000 units; and the computing operation limit associated with “Operation 3^{rd} Type” is identified as 5000 units.

With respect to Account 2, as shown, the computing operation limit associated with “Operation 1^{st} Type” is identified as 0 units; the computing operation limit associated with “Operation 2^{nd} Type” is identified as 100 units; and the computing operation limit associated with “Operation 3^{rd} Type” is identified as 5000 units.

As shown, a second area 606 lists distinct computing operations “Operation 1^{st} Type”, “Operation 2^{nd} Type”, and “Operation 3^{rd} Type” together with the pooled limits for Account 1 and Account 2. The pooled computing operation limit for the Operation First Type is identified as 0 units. The pooled computing operation limit for the Operation 2^{nd} Type is identified as 1000 units. The pooled computing operation limit for the Operation 3^{rd} Type is identified as 5000 units.

As will be noted, the specific computing operations have been updated to reflect the initiation of the computing operation, “Operation 1^{st} Type” with respect to Account 1.

As will be further noted, in the embodiment represented by the first example user interface of FIGS. 6-9, each pooled operation limit is an aggregation of the associated specific computing operation limits associated with each account. Specifically, each pooled operation limit is a sum of the associated specific computing operation limits associated with each account.

However, in some implementations, a pooled computing operation limit is an aggregation in the form of a weighted sum of applicable specific operation limits. For example, a specific computing operation limit may be assigned a multiplier reflecting a level of risk associated with the specific computing operation. For example, when the specific computing operation is a file transfer, risk may be associated with a computing operation category based on the level of encryption associated with the computing operation, the level of security of the source directory and/or one or more proxy servers associated with the computing operation, etc. As a further example, when the specific computing operation is an operation associated with a transfer rail system, risk may be associated with a computing operation category based on the security of the particular transfer rail system, credit risk, etc.

A pooled computing operation limit may be determined, at least in part, by an aggregation of a first computing operation limits and a second computing operation limit. However, the pooled operation limit may be further applicable to one or more additional computing operation categories, and may be further determined by an additional aggregation of one or more additional computing operation limits associated with the one or more additional computing operation categories.

In some implementations, a pooled computing operation limit may be calculated as follows:

$${L}_{P} = {w}_{S 1} {L}_{S 1} + {w}_{S 2} {L}_{S 2} + ⋯ + {w}_{S n} {L}_{S n} ;$$

where L_{P} is the pooled computing operation limit, L_{S1} . . . . L_{Sn} are specific computing operation limits applicable to L_{P}, and w₁ . . . wₙ are multipliers associated with specific computing operations 1 to n.

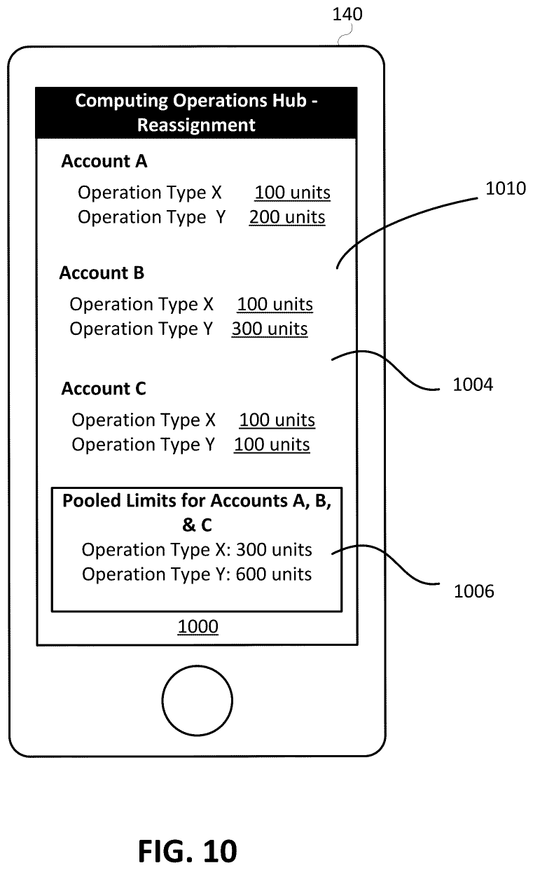

Reference is now made to FIG. 10, which illustrates a first example display screen 1010 of a second example user interface 1000 presented on a client device 140. The second example user interface 1000 may provide for the reassignment of computing operation limits. As shown, the first example display screen 1010 displays a title, “Computing Operations Hub-Reassignment”. The first example display screen 1010 also displays, in a first area 1004, a listing of three resource accounts, Account A, Account B and Account C. The second example user interface 1000 allows a user to easily identify computing operation limits applicable to particular accounts and/or computing operation types.

The first example display screen 1010 of the second example user interface 1000 also displays, in the first area 1004, computing operations and associated limits specific to each of the three resource accounts, Account A, Account B, and Account C. Two distinct computing operations are listed with respect to each of Account A, Account B, and Account C: “Operation Type X”, and “Operation Type Y”.

With respect to Account A, as shown, the specific computing operation limit associated with “Operation Type X” is identified as 100 units, and the specific computing operation limit associated with “Operation Type Y” is identified as 200 units.

With respect to Account B, as shown, the specific computing operation limit associated with “Operation Type X” is identified as 100 units, and the specific computing operation limit associated with “Operation Type Y” is identified as 300 units.

With respect to Account C, as shown, the specific computing operation limit associated with “Operation Type X” is identified as 100 units, and the specific computing operation limit associated with “Operation Type Y” is identified as 100 units.

As shown, a second area 1006 lists the pooled limits for Account A, Account B, and Account C with respect to each of computing operations “Operation Type X”, and “Operation Type Y”. The pooled computing operation limit for the “Operation Type X” is identified as 300 units, and the pooled computing operation limit for the “Operation Type Y” is identified as 600 units.

The first example display screen 1010 may provide computing operation controls. For example, one or more selectable options may be provided for reassigning a computing operation limit. For example, the specific operation limits may each comprise a virtual button.

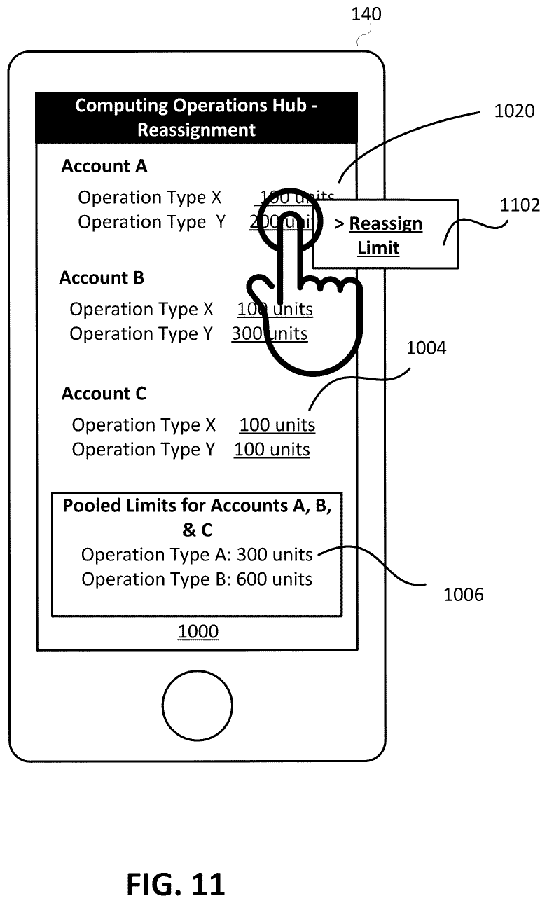

Referring now to FIG. 11, a second example display screen 1020 of the second example user interface 1000 is illustrated. The second example display screen 1020 includes the components of the first example display screen 1010 of FIG. 10. Additionally, the second example display screen 1020 includes one or more selectable options 1102 to reassign a limit in connection with a selected computing operation. Other selectable options may be provided instead of or in addition to this option.

The one or more selectable options 1102 to reassign a limit is shown with respect to the specific limit of 200 units in connection with “Operation Type Y” in connection with “Account A”. The of one or more selectable options 704 to define a data amount is shown with respect to the “Operation 1^{st} Type” in connection with Account 1.

The one or more selectable options 1102 to define a reassign a limit may be displayed when a user activates or otherwise selects one of the listed computing operation limits. In some embodiments, such selection may be made using a touchscreen associated with the client device 140, although other techniques are contemplated.

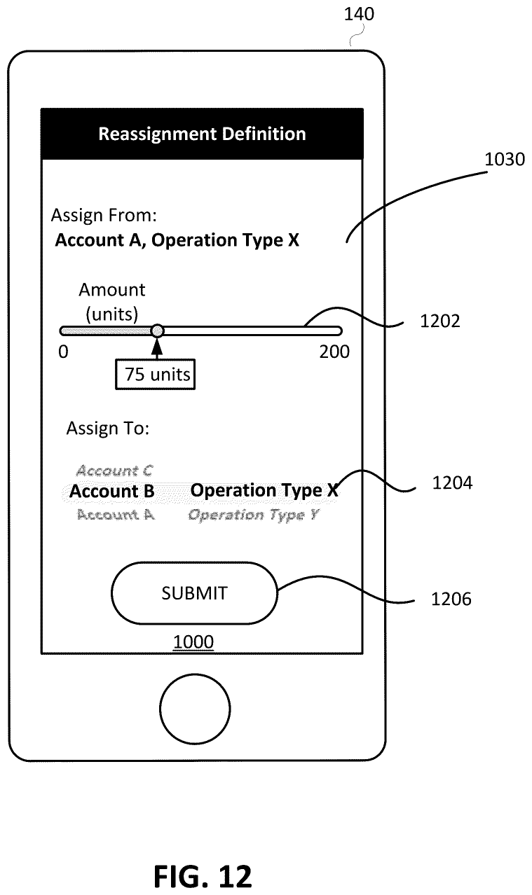

Upon selection of the one or more selectable options 1102 to reassign a limit in connection with a specific computing operation, the client device 140 may then display a third example display screen 1030 (FIG. 12) of the second example user interface 1000 for defining the reassignment. Referring now to FIG. 12, the third example display screen 1030 is illustrated.

As shown, the third example display screen 1030 of the second example user interface 1000 includes a title, “Reassignment Definition”. The third example display screen 1030 further includes an indication of the resource account (“Account A”) and the computing operation (“Operation Type X”) to which the reassignment relates. A range slider 1202 provides for a user selection of an amount of units to be reassigned. The illustrated range is 0 to 200 units, and a selection of 75 units is indicated. A scroll wheel 1204 is shown for use in selecting an account and/or a computing operation type to which to apply the reassignment. “Account B’, and “Operation Type X” are illustrated as selected. A “SUBMIT” button 1206 is additionally included by the third example display screen 1030.

It will be noted that while the third example display screen includes a range slider and a scroll wheel, other techniques for defining an amount and for selecting an account and/or a computing type to which to apply the reassignment are contemplated.

In some embodiments, subsequent to receiving a request to reassign a specific computing operation limit, the system may display, via the client device, a listing of updated computing operation limits.

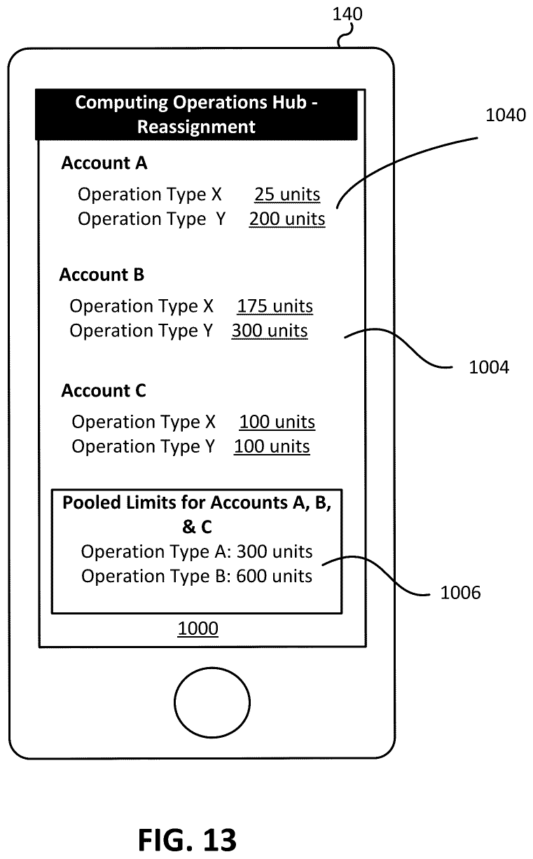

Reference is now made to FIG. 13, which illustrates a fourth example display screen 1040 of a second example user interface 1000 presented on a client device 140. The fourth example display screen 1040 illustrates an example listing of specific and pooled computing operation limits associated with three listed resource accounts, Account A, Account B, and Account C, subsequent to receiving a request to reassign an amount of 75 units of the specific computing operation limit in connection with “Operation Type X” and “Account A” to “Operation Type X” and “Account B”.

As shown, the fourth example display screen 1040 displays a title, “Computing Operations Hub-Reassignment”. The example display screen 1040 of the second example user interface 1000 also displays, in the first area 1004, computing operations and associated limits specific to each of the three resource accounts: Account A, Account B, and Account C. Two distinct computing operations are listed with respect to each of Account A, Account B and Account C: “Operation Type X” and “Operation Type Y”.

With respect to Account A, as shown, the specific computing operation limit associated with “Operation Type X” is identified as 25 units, and the specific computing operation limit associated with “Operation Type Y” is identified as 200 units.

With respect to Account B, as shown, the specific computing operation limit associated with “Operation Type X” is identified as 175 units, and the specific computing operation limit associated with “Operation Type Y” is identified as 300 units.

With respect to Account C, as shown, the specific computing operation limit associated with “Operation Type X” is identified as 100 units, and the specific computing operation limit associated with “Operation Type Y” is identified as 100 units.

As shown, a second area 1006 lists the pooled limits for Account A, Account B, and Account C with respect to each of computing operations “Operation Type X”, and “Operation Type Y”. The pooled computing operation limit for the “Operation Type X” is identified as 300 units, and the pooled computing operation limit for the “Operation Type Y” is identified as 600 units.

As will be noted, the specific computing operation limits have been updated to reflect a reassignment of 25 units of specific computing operation limit from “Operation Type X”,

“Account A” to “Operation Type X”, “Account B”.

As will be further noted, in the embodiment represented by the second example user interface of FIGS. 10-13, each pooled operation limit is an aggregation of the associated specific computing operation limits associated with each account. Specifically, each pooled operation limit is a sum of the associated specific computing operation limits associated with each account.

However, in some implementations, a pooled computing operation limit is an aggregation in the form of a weighted sum of applicable specific operation limits.

In some implementations, a pooled computing operation limit may be calculated as follows:

$${L}_{P} = {w}_{S 1} {L}_{S 1} + {w}_{S 2} {L}_{S 2} + ⋯ + {w}_{S n} {L}_{S n} ;$$

where L_{P} is the pooled computing operation limit, L_{S1} . . . . L_{Sn} are specific computing operation limits applicable to L_{P}, and w₁ . . . wₙ are multipliers associated with specific computing operations 1 to n.

As a result, in some embodiments, reassigning at least a portion of the second computing operation limit to the first computing operation limit may include applying a multiplier to the at least a portion of the second computing operation limit, the multiplier being based on a level of relative risk between the first computing operation and the second computing operation.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

1. A computer system comprising:
a processor; and
a memory coupled to the processor and storing instructions that, when executed by the processor, cause the computer system to:
define a first computing operation limit specific to a first computing operation category, the first computing operation category being a computing operation of a first type in connection with a first resource account;
define a pooled computing operation limit applicable to both the first computing operation category and to a second computing operation category;
determine that a defined amount of data associated with a requested computing operation in connection with the first computing operation category exceeds the first computing operation limit;
determine that the defined amount of data associated with the requested computing operation is within the pooled computing operation limit; and
enable the requested computing operation.

2. The computer system of claim 1, wherein a second computing operation limit specific to the second computing operation category is defined, and wherein the system is further caused to, prior to enabling the requested computing operation:
reassign at least a portion of the second computing operation limit to the first computing operation limit.

3. The computer system of claim 2, wherein the computer system is further caused to:
generate an updated first computing operation limit to reflect the defined amount of data associated with the requested computing operation; and
generate an updated pooled computing operation limit to reflect the defined amount of data associated with the requested computing operation.

4. The computer system of claim 3, wherein the computer system is further caused to, prior to determining that a defined amount of data associated with a requested computing operation in connection with the first computing operation category exceeds the first computing operation limit:
display, via a client device, a listing of one or more resource accounts, the listing including at least the first resource account;
display, via the client device, in connection with each of the one or more resource accounts, an indication of at least one computing operation limit associated with one or more computing operation types, the one or more computing operation types including the computing operation of the first type; and
receive, via the client device, a request to initiate the computing operation of the first type with respect to the defined amount of data in connection with the first resource account.

5. The computer system of claim 4, wherein the computer system is further caused to:
display, via the client device, the updated first computing operation limit and the updated pooled operation limit.

6. The system of claim 2, wherein the pooled computing operation limit is determined, at least in part, by an aggregation of the first computing operation limit and the second computing operation limit.

7. The system of claim 6, wherein the pooled computing operation limit is further applicable to one or more additional computing operation categories, and is further determined by an additional aggregation of one or more additional computing operation limits associated with the one or more additional computing operation categories.

8. The system of claim 2, wherein reassigning at least the portion of the second computing operation limit to the first computing operation limit includes applying a multiplier to the at least the portion of the second computing operation limit, the multiplier being based on a level of relative risk between the first computing operation category and the second computing operation category.

9. The system of claim 1, wherein the second computing operation category is a computing operation of a second type from the first resource account.

10. The system of claim 1, wherein the second computing operation category is a computing operation of the first type from a second resource account.

11. A computer-implemented method comprising:
defining a first computing operation limit specific to a first computing operation category, the first computing operation category being a computing operation of a first type in connection with a first resource account;
defining a pooled computing operation limit applicable to both the first computing operation category and to a second computing operation category;
determining that a defined amount of data associated with a requested computing operation in connection with the first computing operation category exceeds the first computing operation limit;
determining that the defined amount of data associated with the requested computing operation is within the pooled computing operation limit; and
enabling the requested computing operation.

12. The method of claim 11, wherein a second computing operation limit specific to the second computing operation category is defined, and wherein the method further comprises, prior to enabling the requested computing operation:
reassigning at least a portion of the second computing operation limit to the first computing operation limit.

13. The method of claim 12, wherein the method further comprises:
generating an updated first computing operation limit to reflect the defined amount of data associated with the requested computing operation; and
generating an updated pooled operation limit to reflect the defined amount of data associated with the requested computing operation.

14. The method of claim 13, wherein the method further comprises, prior to determining that a defined amount of data associated with a requested computing operation in connection with the first computing operation category exceeds the first computing operation limit:
displaying, via a client device, a listing of one or more resource accounts, the listing including at least the first resource account;
displaying, via the client device, in connection with each of the one or more resource accounts, an indication of at least one computing operation limit associated with one or more computing operation types, the one or more computing operation types including the computing operation of the first type; and
receiving, via the client device, a request to initiate the computing operation of the first type with respect to the defined amount of data in connection with the first resource account.

15. The method of claim 14, wherein the method further comprises:
displaying, via the client device, the updated first computing operation limit and the updated pooled operation limit.

16. The method of claim 12, wherein the pooled computing operation limit is determined, at least in part, by an aggregation of the first computing operation limit and the second computing operation limit.

17. The method of claim 16, wherein the pooled computing operation limit is further applicable to one or more additional computing operation categories, and is further determined by an additional aggregation of one or more additional computing operation limits associated with the one or more additional computing operation categories.

18. The method of claim 12, wherein reassigning at least the portion of the second computing operation limit to the first computing operation limit includes applying a multiplier to the at least the portion of the second computing operation limit, the multiplier being based on a level of relative risk between the first computing operation category and the second computing operation category.

19. The method of claim 11, wherein the second computing operation category is a computing operation of a second type from the first resource account.

20. A non-transitory computer readable medium containing instructions which, when executed by a processor, cause the processor to:
define a first computing operation limit specific to a first computing operation category, the first computing operation category being a computing operation of a first type in connection with a first resource account;
define a pooled computing operation limit applicable to both the first computing operation category and to a second computing operation category;
determine that a defined amount of data associated with a requested computing operation in connection with the first computing operation category exceeds the first computing operation limit;
determine that the defined amount of data associated with the requested computing operation is within the pooled computing operation limit; and
enable the requested computing operation.
